(19) United States
(12) Patent Application Publication
(10) Pub. No.: US 2007/0100101 A1
(43) Pub. Date: May 3, 2007

(54) Fluoroelastomers containing copolymerized units of vinyl esters

(76) Inventors: Ming-Hong Hung, Wilmington, DE (US); Phan Linh Tang, West Chester, PA (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 11/540,420

(22) Filed: Sep. 29, 2006

Related U.S. Application Data
(60) Provisional application No. 60/731,574, filed on Oct. 28, 2005.

(51) Int. Cl. C08F 214/18

(52) U.S. Cl. 526/250

(57) ABSTRACT

Fluoroelastomers are disclosed that comprise copolymerized units of a vinyl ester of the formula CH₂═CHOC(O)R, wherein R is a C₁-C₄ alkyl group and at least one monomer selected from the group consisting of tetrafluoroethylene and a perfluoro(alkyl vinyl ether). The elastomers may further contain copolymerized units of a hydrocarbon olefin such as ethylene or propylene. Optionally, fluoroelastomers of the invention may contain copolymerized units of a cure site monomer or a cure site monomer. Pendant ester groups on the fluoroelastomer may be at least partially saponified.

### CROSS REFERENCE TO RELATED APPLICATIONS

This application claims the benefit of U.S. Provisional Application No. 601731,574 filed Oct. 28, 2005.

### FIELD OF THE INVENTION

This invention relates to elastomeric copolymers comprising copolymerized units of a vinyl ester and at least one fluoromonomer selected from the group consisting of tetrafluoroethylene and a perfluoro(alkyl vinyl ether).

### BACKGROUND OF THE INVENTION

Fluoroelastomers comprising copolymers of tetrafluoroethylene (TFE), a perfluoro(alkyl vinyl ether) (PAVE) and a cure site monomer are known in the art (U.S. Pat. Nos. 5,789,489; 4,214,060). Such elastomers have excellent chemical and thermal resistance.

Base resistant fluoroelastomers made from copolymers of ethylene (E), a perfluoro(alkyl vinyl ether) (PAVE), tetrafluoroethylene (TFE) and a cure site monomer are known in the art (U.S. Pat. No. 4,694,045). In addition to being resistant to attack by strong bases, these fluoroelastomers have good sealing properties at both low and high temperatures and exhibit low swell in oil.

In order to fully develop physical properties such as tensile strength, elongation, and compression set, elastomers must be cured, i.e. crosslinked. In the case of fluoroelastomers, this is generally accomplished by mixing uncured polymer (i.e. fluoroelastomer gum) with a polyfunctional curing agent and heating the resultant mixture, thereby promoting chemical reaction of the curing agent with active sites along the polymer backbone or side chains. Interchain linkages produced as a result of these chemical reactions cause formation of a crosslinked polymer composition having a three-dimensional network structure. Commonly used curing agents for fluoroelastomers include difunctional nucleophilic reactants, such as polyhydroxy compounds or diamines. Alternatively, peroxidic curing systems containing organic peroxides and unsaturated coagents, such as polyfunctional isocyanurates, may be employed.

U.S. Pat. No. 3,449,305 discloses copolymers of 50-85 weight percent vinylidene fluoride, 5-37 weight percent tetrafluoroethylene and 5-50 weight percent of a vinyl ester. The copolymers may also optionally contain copolymerized hexafluoropropylene, chlorotrifluoroethylene, trifluoropropene, ethylene, propylene or an alkyl vinyl ether.

U.S. Pat. No. 5,851,593 discloses amorphous copolymers of a vinyl ester with a fluoromonomer such as tetrafluoroethylene, vinylidene fluoride, hexafluoropropylene and certain functionalized fluorovinyl ethers.

### SUMMARY OF THE INVENTION

Vinyl esters were found to copolymerize surprisingly well with perfluoro(alkyl vinyl ethers), even in the presence of other fluorinated and non-fluorinated monomers. The copolymerized units of vinyl esters can provide cure sites, improve curing characteristics and adhesion to other substrates.

An aspect of the present invention is a fluoroelastomer comprising copolymerized units of 35 to 75 mole percent tetrafluoroethylene; 0 to 40 mole percent of a perfluoro(alkyl vinyl ether); 0 to 40 mole percent of a hydrocarbon olefin selected from the group consisting of ethylene and propylene; 0 to 5 mole percent vinylidene fluoride; and 0.25 to 30 mole percent of a vinyl ester having the formula CH₂═CHOC(O)R, wherein R is a C₁-C₄ alkyl group, with the proviso that if the mole percent of perfluoro(alkyl vinyl ether) is 0%, said fluoroelastomer contains at least 10 mole percent propylene and wherein the sum of all copolymerized units is 100 mole percent. Mole percentages are based on the total moles of copolymerized monomer units in the fluoroelastomers.

Another aspect of this invention is a fluoroelastomer comprising copolymerized units of 0 to 75 mole percent tetrafluoroethylene; a perfluoro(alkyl vinyl ether); and a vinyl ester having the formula CH₂═CHOC(O)R, wherein R is a C₁-C₄ alkyl group and wherein the sum of all copolymerized units is 100 mole percent.

### DETAILED DESCRIPTION OF THE INVENTION

Fluoroelastomers of this invention comprise copolymerized units of a vinyl ester having the formula CH₂═CHOC(O)R, wherein R is a C₁-C₄ alkyl group. Specific examples of vinyl esters that may be employed in the fluoroelastomers of this invention include, but are not limited to vinyl formate, vinyl acetate, vinyl propionate and vinyl butyrate.

The fluoroelastomers are substantially free of copolymerized units of vinylidene fluoride. By “substantially free” is meant 5 mole percent or less, preferably 0 mole percent of vinylidene fluoride units are contained in the fluoroelastomer. Restricting the level of vinylidene fluoride in the fluoroelastomers of this invention improves the chemical resistance (e.g. base resistance) of the fluoroelastomers.

Pendant ester groups on copolymerized units of a vinyl ester may be at least partially saponified during polymerization, subsequent processing (e.g. coagulation and drying), and during vulcanization. The degree of saponification, if any, may be controlled by the amount of acid or base present during these processes. A preferred means to saponify the ester groups is by reaction of an aqueous base such as ammonium hydroxide, sodium hydroxide, tetrabutyl ammonium hydroxide, etc. with the fluoroelastomer. Fluoroelastomers of this invention include those wherein the pendant ester groups are 1) not saponified, 2) partially saponified or 3) completely saponified.

In one embodiment of the invention, the fluoroelastomers comprise copolymerized units of 35 to 75 mole percent tetrafluoroethylene; 0 to 40 mole percent of a perfluoro(alkyl vinyl ether); 0 to 40 mole percent of a hydrocarbon olefin selected from the group consisting of ethylene and propylene; and 0.25 to 30 mole percent of a vinyl ester having the formula CH₂═CHOC(O)R, wherein R is a C₁-C₄ alkyl group. If the fluoroelastomer does not contain units of a perfluoro(alkyl vinyl ether), i.e. 0 mole percent, then the fluoroelastomer contains at least 10 (preferably at least 16) mole percent copolymerized units of propylene. Mole percentages are based on the total moles of copolymerized monomer units in the fluoroelastomers. The sum of all copolymerized units is 100 mole percent.

In another embodiment of the invention, the fluoroelastomers comprise copolymerized units of 0 to 75 mole percent tetrafluoroethylene; a perfluoro(alkyl vinyl ether); and a vinyl ester having the formula CH₂═CHOC(O)R, wherein R is a C₁-C₄ alkyl group.

Perfluoro(alkyl vinyl ethers) suitable for use as monomers include those of the formula
CF₂═CFO(R_{f′}O)ₙ(R_{f″}O)ₘR_{f} (I)
where R_{f′} and R_{f″}, are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl ethers) includes compositions of the formula
CF₂═CFO(CF₂CFXO)ₙR_{f} (II)
where X is F or CF₃, n is 0-5, and R_{f} is a perfluoroalkyl group of 1-6 carbon atoms.

A most preferred class of perfluoro(alkyl vinyl ethers) includes those ethers wherein n is 0 or 1 and R_{f} contains 1-3 carbon atoms. Examples of such perfluorinated ethers include perfluoro(methyl vinyl ether) (PMVE) and perfluoro(propyl vinyl ether) (PPVE). Other useful monomers include compounds of the formula
CF₂═CFO[(CF₂)ₘCF₂CFZO]ₙR_{f} (III)

where R_{f} is a perfluoroalkyl group having 1-6 carbon atoms,

m=0 or 1, n=0-5, and Z=F or CF₃.

Preferred members of this class are those in which R_{f} is C₃F₇, m=0, and n=1.

Additional perfluoro(alkyl vinyl ether) monomers include compounds of the formula
CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5. Preferred members of this class include compounds where n=0-1, m=0-1, and x=1.

Additional examples of useful perfluoro(alkyl vinyl ethers) include
CF₂═CFOCF₂CF(CF₃)O(CF₂O)ₘCₙF₂ₙ₊₁ (V)

where n=1-5, m=1-3, and where, preferably, n=1.

Fluoroelastomers of the invention may, optionally, further comprise 0.05 to 10 mole percent copolymerized units of one or more cure site monomers. Examples of suitable cure site monomers include, but are not limited to: i) bromine -containing olefins; ii) iodine-containing olefins; iii) bromine-containing vinyl ethers; iv) iodine-containing vinyl ethers; v) fluorine-containing olefins having a nitrile group; vi) fluorine-containing vinyl ethers having a nitrile group; vii) 1,1,3,3,3-pentafluoropropene (2-HPFP); viii) perfluoro(2-phenoxypropyl vinyl) ether; ix) 3,3,3-trifluoropropene-1; x) trifluoroethylene; xi) 1,2,3,3,3-pentafluoropropylene; xii) 1,1,3,3,3-pentafluoropropylene; xiii) 2,3,3,3-tetrafluoropropene and xiv) non-conjugated dienes.

Brominated cure site monomers may contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R—O—CF═CF₂ (R_{f} is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr.

Suitable iodinated cure site monomers include iodinated olefins of the formula: CHR═CH—Z—CH₂CHR—I, wherein R is —H or —CH₃; Z is a C₁-C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂O[CF(CF₃)CF₂O]ₙCF═CF₂, and the like, wherein n=1-3, such as disclosed in U.S. Pat. No. 5,717,036. In addition, suitable iodinated cure site monomers including iodoethylene, 4-iodo-3,3,4,4-tetrafluorobutene-1 (ITFB); 3-chloro-4-iodo-3,4,4-trifluorobutene; 2-iodo-1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether are also useful cure site monomers.

Useful nitrile-containing cure site monomers include those of the formulas shown below.
CF₂═CF—O(CF₂)ₙ—CN (VI)

where n=2-12, preferably 2-6;
CF₂═CF—O[CF₂—CF(CF₃)—O]ₙ—CF₂—CF(CF₃)—CN (VII)

where n=0-4, preferably 0-2;
CF₂═CF—[OCF₂CF(CF₃)]ₓ—O—(CF₂)ₙ—CN (VIII)

where x=1-2, and n=1-4; and
CF₂═CF—O—(CF₂)ₙ—O—CF(CF₃)CN (IX)

where n=2-4.

Those of formula (VlIl) are preferred. Especially preferred cure site monomers are perfluorinated polyethers having a nitrile group and a trifluorovinyl ether group. A most preferred cure site monomer is
CF₂═CFOCF₂CF(CF₃)OCF₂CF₂CN (X)
i.e. perfluoro(8-cyano-5-methyl-3,6-dioxa-1-octene) or 8-CNVE.

Examples of non-conjugated diene cure site monomers include, but are not limited to 1,4-pentadiene; 1,5-hexadiene; 1,7-octadiene; 3,3,4,4-tetrafluoro-1,5-hexadiene; and others, such as those disclosed in Canadian Patent 2,067,891 and European Patent 0784064A1. A suitable triene is 8-methyl-4-ethylidene-1,7-octadiene.

Of the cure site monomers listed above, preferred compounds, for situations wherein the fluoroelastomer will be cured with peroxide, include 4-bromo-3,3,4,4-tetrafluorobutene-1 (BTFB); 4-iodo-3,3,4,4-tetrafluorobutene-1 (ITFB); allyl iodide; bromotrifluoroethylene and 8-CNVE. When the fluoroelastomer will be cured with a polyol, 2-HPFP or perfluoro(2-phenoxypropyl vinyl) ether is the preferred cure site monomer. When the fluoroelastomer will be cured with a tetraamine, an ammonia generating compound such as urea, bis(aminophenol) or bis(thioaminophenol), 8-CNVE is the preferred cure site monomer.

Alternatively, or in addition to copolymerized units of cure site monomers, bromine or iodine cure sites may optionally be introduced onto the fluoroelastomer polymer chain ends by use of iodinated or brominated chain transfer agents such as methylene iodide or 1,4-diiodoperfluoro-butane during polymerization.

Fluoroelastomers of this invention may, optionally, further comprise copolymerized fluorovinyl ethers that contain a functional group such as an alcohol or carboxylic acid group. Examples of such functional vinyl ethers include, but are not limited to CF₂═CF(OCF₂CF(CF₃))ₙOₚ(CF₂)ₘA, wherein A is —CH₂OH or —COOH, p=0 or 1, m=0 to 10 and n=1 to 20, provided that when m=0, p=0 and when n>0, p=1. Preferred functional fluorovinyl ethers include CF₂═CFOCF₂CF(CF₃)OCF₂CF₂CH₂OH (EVE-OH) as disclosed in U.S. Pat. No. 4,982,009; CF₂═CFOCF₂CF(CF₃)OCF₂CF₂COOH (EVE-COOH) disclosed in U.S. Pat. No. 4,138,426; CF₂═CFOCF₂CF(CF₃)OCF₂CF₂SO₂F (PSEPVE); CF₂═CFOCF₂CF(CF₃)OCF₂CF₂COOR (EVE) wherein R is an alkyl group, preferably methyl); and CF₂═CFOCF₂CF(CF₃)OCF₂CF₂CH₂O—P(O)(OR₁)₂ (EVE-P) wherein R₁ is a hydrogen, sodium or potassium ion.

Specific examples of the fluoroelastomers of this invention include, but are not limited to copolymerized units of i) TFE/PMVE/Vc; ii) PMVE/VAc; iii) TFE/P/VAc/TFP; and iv) TFE/PMVE/E/VAc wherein “TFE” is tetrafluoroethylene, “PMVE” is perfluoro(methyl vinyl ether), “VAc” is vinyl acetate, “TFP” is 3,3,3-trifluoropropene-1, “P” is propylene and “E” is ethylene.

The fluoroelastomers of this invention are generally prepared by free radical emulsion or suspension polymerization. Preferably, the polymerizations are carried out in continuous, batch, or semi-batch emulsion processes well known in the art. The resulting fluoroelastomer latexes are usually coagulated by addition of electrolytes. The precipitated polymer is washed with water and then dried, for example in an air oven, to produce a substantially dry fluoroelastomer gum.

In a semi-batch emulsion polymerization process, a gaseous monomer mixture of a desired composition (initial monomer charge) is introduced into a reactor which contains an aqueous solution. Generally, the pH of the aqueous solution is controlled with base (e.g. caustic) or a buffer (e.g. a phosphate) to between 1 and 8 (preferably 3-7), depending upon the type of fluoroelastomer being made. In addition, the initial aqueous solution may contain a surfactant and/or a nucleating agent, such as a fluoroelastomer seed polymer prepared previously, in order to promote fluoroelastomer latex particle formation and thus speed up the polymerization process.

The amount of monomer mixture contained in the initial charge is set so as to result in a reactor pressure between 0.5 and 10 MPa.

The monomer mixture is dispersed in the aqueous medium and, optionally, a chain transfer agent may also be added at this point while the reaction mixture is agitated, typically by mechanical stirring.

The temperature of the semi-batch reaction mixture is maintained in the range of 25° C.-130° C., preferably 50° C.-100° C. Polymerization begins when the initiator either thermally decomposes or reacts with reducing agent and the resulting radicals react with dispersed monomer.

Additional quantities of the gaseous major monomers and cure site monomer (incremental feed) are added at a controlled rate throughout the polymerization in order to maintain a constant reactor pressure at a controlled temperature. The polymerization pressure is controlled in the range of 0.5 to 10 MPa, preferably 1 to 6.2 MPa.

Polymerization times in the range of from 2 to 30 hours are typically employed in this semi-batch polymerization process.

A suitable continuous emulsion polymerization process differs from the semi-batch process in the following manner. In the continuous process, gaseous monomers and solutions of other ingredients such as water-soluble monomers, chain transfer agents, buffer, bases, polymerization initiator, surfactant, etc., are fed to the reactor in separate streams at a constant rate. The temperature of the continuous process reaction mixture is maintained in the range of 25° C.-130° C., preferably 80° C.-120° C.

The invention is now illustrated by the following embodiments in which all parts are by weight unless otherwise indicated.

### EXAMPLES

Test Methods

Mooney viscosity, ML (1+10), was determined according to ASTM D1646 with a large (L) rotor at 121° C. using a preheating time of 1 minute and a rotor operation time of 10 minutes.

¹⁹F-NMR was run at room temperature, unless otherwise specified, on a Bruker DRX 400 spectrometer with a Quad Probe (SN Z8400/0026), using a 90° pulse of 7.5 μs, a spectral width of 150 KHz and a recycle delay (d1) of 10 s. A total of 16 scans were acquired.

¹H-NMR was run at room temperature on the same spectrometer and same probe as the ¹⁹F-NMR. A 90° pulse of 11.2 μs, a spectral width of 10 KHz and a recycle delay (d1) of 30 s was employed. A total of 16 scans were obtained.

T_{g} was determined by DSC on a TA Instruments 2920 using a heating rate of 10° C./min. and a nitrogen atmosphere.

### Example 1

A 1-liter stainless reactor was charged with deionized water (450 mL), the ammonium salt of perfluorononanoic acid (surfactant, 3.0 g), disodium phosphate heptahydrate (2.0 g) and ammonium persulfate (0.4 g), along with the vinyl acetate (VAc) monomer (5.0 g). The reactor was sealed and cool-evacuated (i.e. cooled below room temperature and then evacuated to remove oxygen) several times. Tetrafluoroethylene (TFE) (45 g) and perfluoro(methylvinyl ether) (PMVE) (40 g) were then transferred into the reactor. The polymerization was initiated and allowed to proceed at 70° C. for 8 hrs with an agitation speed of 900 rpm. The resulting polymer latex was coagulated with saturated magnesium sulfate solution. Precipitated polymer was collected by filtration. Polymer was washed thoroughly with warm water, and then dried in a vacuum oven at 80° C. 29.4 grams of white polymer was obtained. This polymer had a T_{g} at +0.2° C. as measured by DSC. The composition of the polymer was TFE/PMVE/VAc=60.0/32.0/8.0 (mole %) as determined by ¹H and ¹⁹F-NMR in hexafluorobenzene solvent at 70° C.

### Example 2

A 1-liter reactor was charged with deionized water (550 mL), the ammonium salt of perfluorononanoic acid (surfactant, 3.0 g), disodium phosphate heptahydrate (2.0 g) and ammonium persulfate (0.4 g), along with the vinyl acetate (VAc) monomer (10.8 g). The reactor was sealed and cool-evacuated several times. PMVE (62.3 g) was then transferred into the reactor. Polymerization was initiated and allowed to proceed at 70° C. for 8 hrs. The resulting polymer latex was coagulated with saturated magnesium sulfate solution. Precipitated polymer was collected by filtration. Polymer was washed thoroughly with warm water, and then dried in a vacuum (150 mmHg) at 80° C. 19.1 grams of white polymer was obtained. This polymer had a T_{g} at 23° C. as measured by DSC. The composition of the polymer was PMVE/VAc=31.7/68.3 (mole %) as determined by ¹H and ¹⁹F-NMR in hexafluorobenzene solvent at ambient temperature.

### Example 3

A polymer of the invention was prepared by a semi-batch emulsion polymerization process, carried out at 60° C. in a well-stirred reaction vessel. A 33-liter, horizontally agitated reactor was charged with 23 liters of deionized, deoxygenated water, 115 g active ingredient of Forafac 1033D surfactant, and 13.5 g isopropanol. The reactor was heated to 60° C. and then pressurized to 2.07 MPa with a mixture of 96 wt. % tetrafluoroethylene (TFE), 2 wt. % propylene (P), and 2 wt. % 3,3,3-trifluoropropene-1 (TFP). An 812 ml aliquot of a 10 wt. % ammonium persulfate initiator aqueous solution was then added. A gas monomer mixture of 79.8 wt. % TFE, 16.0 wt. % P, and 4.3 wt. % TFP was supplied to the reactor to maintain a pressure of 2.07 MPa throughout the polymerization. The initiator solution was fed continuously at 15 ml/hour through the end of the reaction period. After 80 g of the gas monomer mixture had been fed, vinyl acetate (VAc) feed was begun separately at a ratio of 6 g VAc to 94 g gas monomer mixture until a total of 451 g VAc had been fed. After a total of 7532 g gas monomer mixture had been supplied to the reactor, monomer addition was discontinued and the reactor was purged of residual monomer. The total reaction time was 13 hours.

Polymer A was made from a portion of the above fluoroelastomer latex that had been coagulated by addition of an aqueous aluminum sulfate solution and then filtered. The fluoroelastomer was washed with deionized water and dried for two days at 60° C.

Polymer B was made from another portion of the above latex that had been raised to a pH of 10 with NaOH and then aged at room temperature at pH 10 for 24 hours. The pH of aged latex was lowered to less than 5 with sulfuric acid before coagulating the aged latex by addition of an aqueous aluminum sulfate solution. Filtered fluoroelastomer was then washed with deionized water and dried for two days at 60° C.

Both Polymer A and Polymer B had a glass transition temperature of 2.4° C. as determined by differential scanning calorimetry (heating mode, 10° C./minute, inflection point of transition), a composition of TFE/P/VAc/TFP=63.0/30.4/5.0/1.6 (mole %) as analyzed by ¹H and ¹⁹F-NMR in hexafluorobenzene solvent at ambient temperature, and a Mooney viscosity, ML-10 (121° C.), 51. The pendant vinyl ester groups on Polymer B had been partially saponified, about 15%, as determined by comparing the infrared carbonyl absorption region of Polymer B with that of Polymer A (not saponified).

### Example 4

A polymer of the invention was prepared by a semi-batch emulsion polymerization process, carried out at 60° C. in a well-stirred reaction vessel. A 33-liter, horizontally agitated reactor was charged with 23 liters of deionized, deoxygenated water, and 115 g active ingredient of Forafac 1033D. The reactor was heated to 60° C. and then pressurized to 2.07 MPa with a mixture of 96 wt. % TFE, 2 wt. % propylene (P), and 2 wt. % 3,3,3-trifluoropropene-1 (TFP). An 812 ml aliquot of a 10 wt. % ammonium persulfate initiator aqueous solution was then added. A gas monomer mixture of 79.2 wt. % TFE, 16.7 wt. % P, and 4.2 wt. % TFP was supplied to the reactor to maintain a pressure of 2.07 MPa throughout the polymerization. The initiator solution was fed continuously at 15 ml/hour through the end of the reaction period. After 80 g of the gas monomer mixture had been fed, VAc feed was begun separately at a ratio of 4 g VAc to 96 g gas monomer mixture until a total of 307 g VAc had been fed. After a total of 7680 g gas monomer mixture had been supplied to the reactor, monomer addition was discontinued and the reactor was purged of residual monomer. The total reaction time was 12 hours. The resulting fluoroelastomer latex was coagulated by addition of an aqueous aluminum sulfate solution and the filtered fluoroelastomer was washed with deionized water. The polymer crumb was dried for two days at 60° C. The product had a glass transition temperature of 6.9° C. as determined by differential scanning calorimetry (heating mode, 10° C./minute, inflection point of transition), a composition of TFE/P/VAc/TFP=63.3/31.8/3.2/1.7 (mole %) as analyzed by ¹H and ¹⁹F-NMR in hexafluorobenzene solvent at ambient temperature, and a Mooney viscosity, ML-10 (121° C.), 94.

### Example 5

A polymer of the invention was prepared by a semi-batch emulsion polymerization process, carried out at 80° C. in a well-stirred reaction vessel. A 2-liter reactor was charged with 1200 g of deionized, deoxygenated water, 32 g ammonium perfluorooctanoate, and 6 g disodium phosphate heptahydrate. The reactor was heated to 80° C. and then pressurized to 2.07 MPa with a mixture of 30 wt. % TFE and 70 wt. % PMVE. A 14.8 ml aliquot of a 0.2 wt. % ammonium persulfate initiator aqueous solution was then added. A gas monomer mixture of 7.7 wt. % ethylene (E), 45.4 wt. % TFE, and 46.9 wt. % PMVE was supplied to the reactor to maintain a pressure of 2.07 MPa throughout the polymerization. The initiator solution was fed continuously at 5.0 ml/hour through the end of the reaction period. After 4 g of the gas monomer mixture had been fed, VAc feed was begun separately at a ratio of 3 g VAc to 97 g gas monomer mixture until a total of 12.4 g VAc had been fed. After a total of 417 g gas monomer mixture was supplied to the reactor, monomer addition was discontinued and the reactor was purged of residual monomer. The total reaction time was 10 hours. The resulting fluoroelastomer latex was coagulated by addition of an aqueous aluminum sulfate solution and the filtered fluoroelastomer was washed with deionized water. The polymer crumb was dried for two days at 60° C. The product had a glass transition temperature of −11.1° C. as determined by differential scanning calorimetry (heating mode, 10° C./minute, inflection point of transition), and a composition of TFE/PMVE/E/VAc=46.7127.3/25.210.8 (mole %) as analyzed by ¹H and ¹⁹F-NMR in hexafluorobenzene solvent at ambient temperature.

### Example 6

A polymer of the invention was prepared by a semi-batch emulsion polymerization process, carried out at 80° C. in a well-stirred reaction vessel. A 2-liter reactor was charged with 1200 g of deionized, deoxygenated water, 32 g ammonium perfluorooctanoate, and 6 g disodium phosphate heptahydrate. The reactor was heated to 80° C. and then pressurized to 2.07 MPa with a mixture of 30 wt. % TFE, 70 wt. % PMVE. A 14.8 ml aliquot of a 0.2 wt. % ammonium persulfate initiator aqueous solution was then added. A gas monomer mixture of 51.3 wt. % TFE, and 48.7 wt. % PMVE was supplied to the reactor to maintain a pressure of 2.07 MPa throughout the polymerization. The initiator solution was fed continuously at 5.0 ml/hour through the end of the reaction period. After 4 g of the gas monomer mixture had been fed, VAc feed was begun separately at a ratio of 6.5 g VAc to 93.5 g gas monomer mixture until a total of 26.8 g VAc had been fed. After a total of 417 g gas monomer mixture had been supplied to the reactor, monomer addition was discontinued and the reactor was purged of residual monomer. The total reaction time was 18 hours. The resulting fluoroelastomer latex was coagulated by addition of an aqueous aluminum sulfate solution and the filtered fluoroelastomer was washed with deionized water. The polymer crumb was dried for two days at 60° C. The product had a glass transition temperature of −4.8° C. as determined by differential scanning calorimetry (heating mode, 10° C./minute, inflection point of transition), and a composition of TFE/PMVE/VAc=62.9/34.0/3.1 (mole %) as analyzed by ¹H and ¹⁹F-NMR in hexafluorobenzene solvent at ambient temperature.

What is claimed is:

1. A fluoroelastomer comprising copolymerized units of 35 to 75 mole percent tetrafluoroethylene; 0 to 40 mole percent of a perfluoro(alkyl vinyl ether); 0 to 40 mole percent of a hydrocarbon olefin selected from the group consisting of ethylene and propylene; 0 to 5 mole percent vinylidene fluoride; and 0.25 to 30 mole percent of a vinyl ester having the formula CH₂═CHOC(O)R, wherein R is a C₁-C₄ alkyl group, with the proviso that if the mole percent of perfluoro(alkyl vinyl ether) is 0%, said fluoroelastomer contains at least 10 mole percent propylene and wherein the sum of all copolymerized units is 100 mole percent.

2. A fluoroelastomer of claim 1 further comprising copolymerized units of a cure site monomer.

3. A fluoroelastomer of claim 1 further comprising copolymerized units of a functionalized fluorovinyl ether.

4. A fluoroelastomer of claim 1 wherein pendant ester groups are at least partially saponified.

5. A fluoroelastomer comprising copolymerized units of 0 to 75 mole percent tetrafluoroethylene; a perfluoro(alkyl vinyl ether); and a vinyl ester having the formula CH₂═CHOC(O)R, wherein R is a C₁-C₄ alkyl group and wherein the sum of all copolymerized units is 100 mole percent.

6. A fluoroelastomer of claim 5 further comprising copolymerized units of a cure site monomer.

7. A fluoroelastomer of claim 5 further comprising copolymerized units of a functionalized fluorovinyl ether.

8. A fluoroelastomer of claim 5 wherein pendant ester groups are at least partially saponified.
